(19) United States
(12) Patent Application Publication
(10) Pub. No.: US 2013/0161405 A1
(43) Pub. Date: Jun. 27, 2013

(54) SUPPORT STRUCTURE FOR A SECONDARY LIM RAIL PORTION

(71) Applicant: BOMBARDIER TRANSPORTATION GMBH, Berlin (DE)

(72) Inventor: Harry Skoblenick, Kingston (CA)

(73) Assignee: BOMBARDIER TRANSPORTATION GMBH, Berlin (DE)

(21) Appl. No.: 13/722,558

(22) Filed: Dec. 20, 2012

(30) Foreign Application Priority Data
Dec. 22, 2011 (CA) 2 762 705

(51) Int. Cl. B60L 13/03

(52) U.S. Cl. CPC B60L 13/03
USPC 238/109

(57) ABSTRACT

A support system for a linear induction motor (LIM) rail portion that comprises a plurality of support structures that are attachable at a variety of positions along a length of the LIM rail portion. Each support structure comprises a raised portion that defines a platform for receiving a selection of back-iron component thicknesses or types of the LIM rail portion, and first and second fastening flanges that extend outwardly from respective upper sides of the raised portion. The first and second fastening flanges are attachable to a top cap extrusion of the LIM rail portion. Each support structure further comprises first and second supporting flanges each extending outwardly from respective bottom sides of the raised portion for contacting a surface of the guideway to which the LIM rail portion is to be secured and adjusted for height.

### CROSS REFERENCE TO RELATED APPLICATIONS

This application claims priority to Canadian Application No. 2,762,705, filed on Dec. 22, 2011, which is hereby incorporated by reference in its entirety.

### FIELD OF THE INVENTION

The present invention relates to the field of linear induction motor (LIM) rail installations, and more specifically, to a support system that comprises a plurality of movable support structures for supporting a LIM rail along a LIM rail installation.

### BACKGROUND OF THE INVENTION

Linear induction motors (LIM) for use in railway transit systems require a primary LIM component and a secondary LIM rail. The primary LIM component is generally carried by the railway vehicle, and the secondary LIM rail is generally provided along the railway track. In generally, the secondary LIM rail is a passive portion that interacts with the primary LIM component of the railway vehicle for generating induction currents that provide thrust between the primary LIM component and the secondary LIM rail. In this manner, the railway vehicle is propelled along the railway track over the secondary LIM rail.

The secondary LIM rail is formed of a plurality of secondary LIM rail portions that are positioned one after the other along the full length of a railway installation. The secondary LIM rail portions are located between the two running rails that support the LIM railway vehicle. Typically, the secondary LIM rail portions are constructed by assembling a welded back-iron with a support structure and an aluminum top-cap extrusion. The support structure generally extends along most of the length of the back-iron components and is adapted for securing the secondary LIM portion to a guideway. The process of fabricating this assembly requires specialized equipment and skilled labor in order to cut and machine the components and weld them together using specialized custom jigs. The final welded assembly of the secondary LIM rail portion is then transported to an installation site for being secured to a guideway.

These completed secondary LIM rail portions are heavy and the design cannot be adjusted (other than by cutting or drilling new mounting holes) after assembly. Therefore, for many LIM trackwork installations, custom designed modules are required in order to obtain a customized length or to accommodate special anchor stud spacing along an irregular section of trackwork. The mounting arrangements are also often difficult to access for tightening. Therefore, a deficiency with this traditional manner of fabricating secondary LIM rail portions is their inability to be field-adjustable to accommodate irregular sections of track work. This increases the complexity and cost of manufacturing and installing the secondary LIM rail, as customized secondary LIM rail portions need to be manufactured and transported.

In light of the above, it can be seen that there is a need in the industry for an improved manner of manufacturing, assembling, and installing the LIM secondary rail along a LIM trackwork installation, that alleviates, at least in part, the deficiencies of the prior art.

### SUMMARY OF THE INVENTION

In accordance with a first broad aspect, the present invention provides a support system for a linear induction motor (LIM) rail portion. The support system comprises a plurality of support structures that are attachable at a variety of positions along a length of the LIM rail portion. Each support structure comprises a raised portion that defines a platform for receiving a back-iron component of the LIM rail portion and first and second fastening flanges that extend outwardly from respective upper sides of the raised portion. The first and second fastening flanges are attachable to a top cap extrusion of the LIM rail portion. Each support structure further comprises first and second supporting flanges that each extend outwardly from respective bottom sides of the raised portion for contacting a surface of the guideway to which the LIM rail portion is to be secured.

In accordance with a second broad aspect, the present invention provides a support structure for securing a linear induction motor (LIM) rail portion to a guideway. The support structure is attachable to the LIM rail portion at a variety of positions along a length of the LIM rail portion. The support structure comprises a raised portion defining a platform for supporting the LIM rail portion and a first flange portion and a second flange portion that each extend outwardly from respective bottom sides of the raised portion. A longitudinal axis of the support structure extends perpendicular to a longitudinal axis of the LIM rail portion.

In accordance with a third broad aspect, the present invention provides a support structure for securing a linear induction motor (LIM) rail portion to a guideway. The support structure is attachable to the LIM rail portion at a variety of positions along a length of the LIM rail portion. The support structure comprises a raised portion comprising a platform for supporting the LIM rail portion. The raised portion defines an internal passageway underneath the platform. The support structure further comprises a fastening arrangement for attaching the LIM rail portion to the support structure. The fastening arrangement is positioned outside of the internal passageway.

These and other aspects and features of the present invention will now become apparent to those of ordinary skill in the art upon review of the following description of specific embodiments of the invention and the accompanying drawings. It will also be apparent that this invention could be applied to other technologies having single axle bogies including but not limited to rail vehicles, trolleys, wheeled carts without guide wheels, automotive applications, etc.

### BRIEF DESCRIPTION OF THE DRAWINGS

In the accompanying drawings:

FIG. 1 shows a perspective view of a support system in accordance with a non-limiting example of implementation of the present invention comprising a plurality of support structures for securing a secondary LIM rail portion to a guideway;

FIG. 2 shows a perspective view of a support structure in accordance with a non-limiting example of implementation of the present invention;

FIG. 3 shows a longitudinal cross-sectional view of the support structure of FIG. 2;

FIG. 4 shows a lateral cross-sectional view of the support structure of FIG. 2;

FIG. 5 shows a top plan view of a non-limiting example of implementation of a plurality of support structures in use on a LIM rail installation.

Other aspects and features of the present invention will become apparent to those ordinarily skilled in the art upon review of the following description of specific embodiments of the invention in conjunction with the accompanying figures.

### DETAILED DESCRIPTION

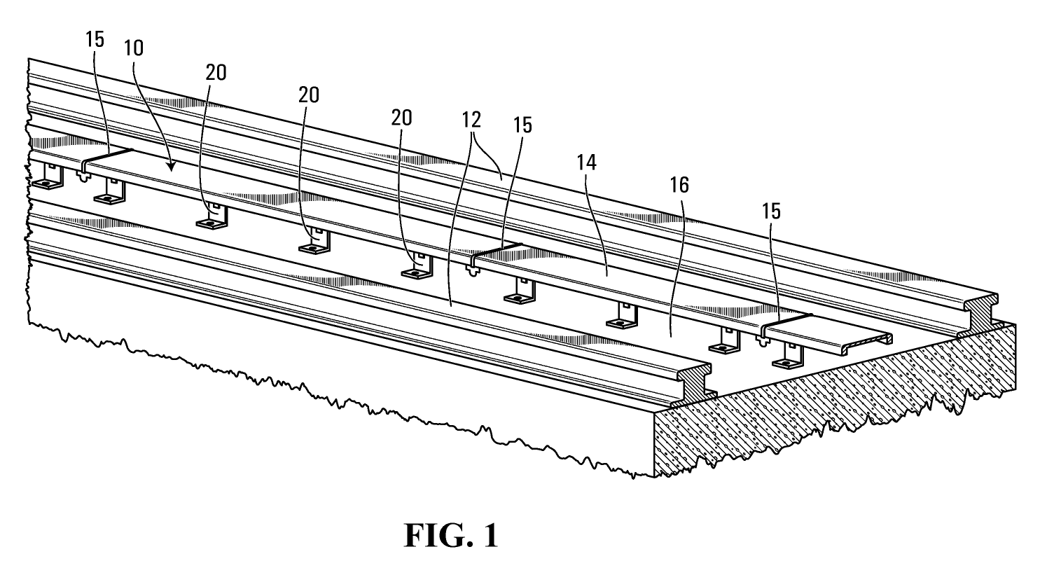

Shown in FIG. 1 is a non-limiting perspective view of a section of a secondary LIM rail installation that comprises three secondary LIM rail portions 10 positioned one after the other along the guideway 16. Given that the secondary LIM rail installation extends along the full length of the railway track, it is desirable that the manner in which the secondary LIM rail portions 10 are manufactured and installed is economical.

In accordance with the present invention, the secondary LIM rail portions 10 are secured to the guideway 16 of the rail installation via a support system that comprises a plurality of support structures 20. The support structures 20 secure the secondary LIM rail portions 10 to the guideway 16 between two running rails 12. As will be described in more detail below, in accordance with the present invention, the support structures 20 are movable in relation to the secondary LIM rail portion 10 such that they can be attached to the secondary LIM rail portion 10 in a variety of positions along its length. This allows the positioning of the support structures 20 in relation to the length of the secondary LIM rail portion 10 to be determined based on the nature of the trackwork at the installation location. This adjustability in the positioning of the support structures 20 allows increased on-site flexibility when securing the secondary LIM rail portion 10 to the guideway. The positioning of the support structures 20 can be adjusted to accommodate irregular sections of the trackwork and sections of the trackwork that have unusually spaced anchor holes

As shown in FIG. 1, when installed, the secondary LIM rail portion 10 is positioned in a raised position in relation to the guideway 16. This raised position allows the second LIM rail portions 10 to interact with the primary LIM component located on the underside of the railway vehicle. As the LIM railway vehicle passes over the railway installation, the primary LIM component interacts with the secondary LIM rail for propelling the railway vehicle forward.

The secondary LIM rail portion 10 comprises an aluminum top cap extrusion 14 and back-iron components (not shown in FIG. 1). The aluminum top cap extrusion 14 provides an electrical path for the currents induced by the magnetic field from the primary LIM component, and the back-iron components complete the magnetic circuit formed between the primary LIM component and the secondary LIM rail portion 10. The manner in which the secondary LIM rail installation and the primary LIM component located on the railway vehicle interact with each other is known in the art, and as such will not be described in more detail herein.

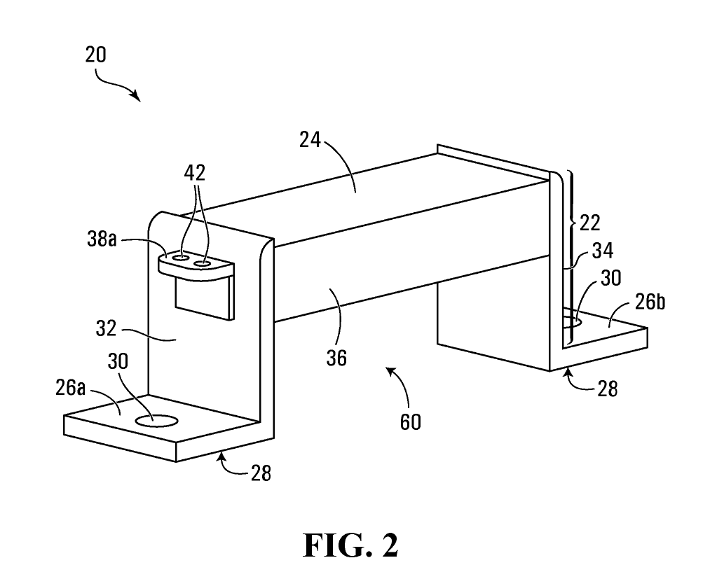

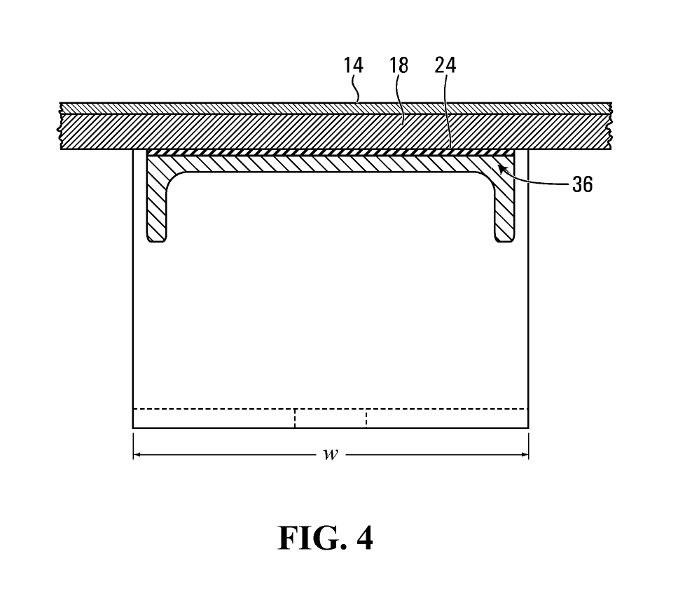

Shown in FIG. 2 is perspective view of a support structure 20 in accordance with a non-limiting example of implementation of the present invention that is suitable for securing a secondary LIM rail portion 10 to the guideway 16. The support structure 20 comprises a raised portion 22 that comprises a first side wall 32 and a second side wall 34 that are interconnected by a platform 24. The platform 24 is operative for supporting the LIM rail portion 10 above the guideway 16. In the non-limiting embodiment shown, the platform 24 is formed from a beam 36 having a U-shaped cross-section (as shown in FIG. 4) that is welded between the first side wall 32 and the second side wall 34. However, it should be appreciated that in other embodiments, the first side wall 32, the second side wall 34 and the platform 24 can be made of a single integral component that is made from a cut and bended piece of material, among other possibilities.

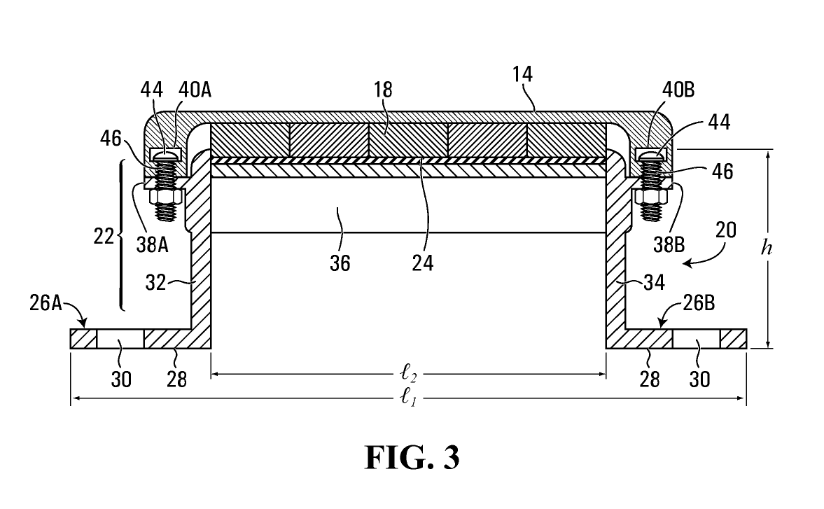

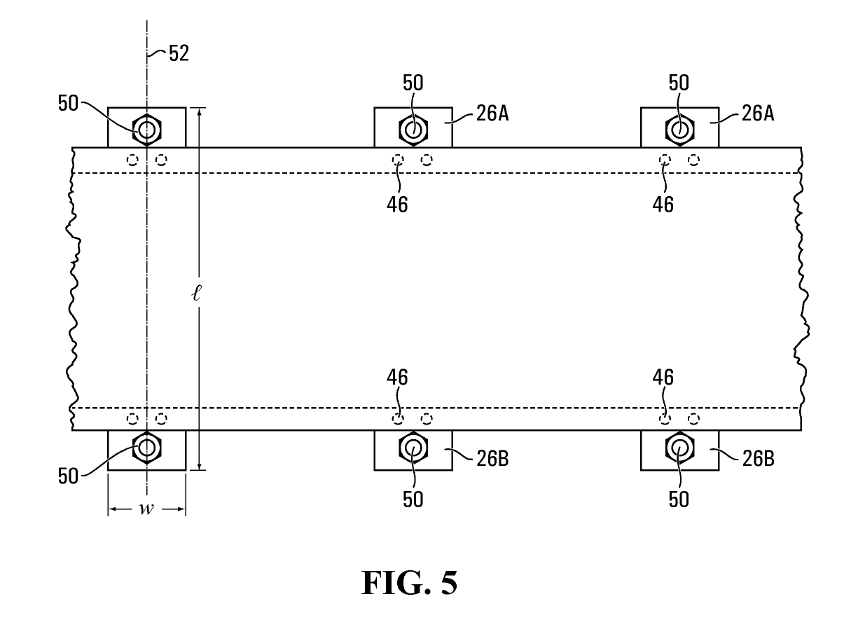

With reference to FIGS. 2 and 3, the support structure 20 further comprises a first supporting flange 26a and a second supporting flange 26b that extend outwardly from respective bottom sides of the raised portion 22. More specifically, the first supporting flange 26a extends from the base of the first side wall 32 and the second supporting flange 26b extends from the base of the second side wall 34. Each of the first and second supporting flanges 26a, 26b comprise a bottom surface 28 for sitting on the surface of the guideway 16 and an aperture 30 for receiving a fastening mechanism 50 (shown in FIG. 5) for fastening the support structure 20, and in turn the LIM rail portion 10, to the guideway 16.

Shown in FIG. 3 is a non-limiting cross sectional view of the support structure 20 with the top cap extrusion 14 and the back-iron components 18 of the LIM rail portion 10 attached thereto. The support structure 20 comprises a fastening arrangement comprising a first fastening flange 38a and a second fastening flange 38b for attaching the LIM rail portion 10 to the support structure. The first fastening flange 38a extends outwardly from a first side wall 32 of the raised portion 22 and the second fastening flange 38b extends outwardly from a second side wall 34 in proximity to the platform 24. Each of the first and second fastening flanges 38a, 38b comprises a pair of apertures 42 through which fastening mechanisms 46, such as bolts, are able to pass for securing the LIM rail portion 10 to the support structure 20. The first and second fastening flanges 38a, 38b can be separate components that are welded to the first and second side walls 32, 34 respectively. Or alternatively, in the case where the raised portion 22 of the support structure 20 is formed via a manufacturing method such as casting, the first and second fastening flanges 38a, 38b can be integrally formed parts of the raised portion 22.

In accordance with a non-limiting example of implementation, the beam 36 that extends between the first side wall 32 and the second side wall 34 is positioned slightly below the upper edges of the first and second side walls 32, 34, such that the platform 24 provides a slight recess for receiving the back-iron component 18. As shown in FIG. 3, the back-iron component 18 is cradled on an elastomer pad on the platform 24 between the first and second side walls 32, 34. The back-iron component 18 is generally formed of a plurality of iron bars that are placed in a side-by-side arrangement and welded together. In addition, the mating surfaces between the back-iron bars are coated with an electrical resistant finish to enhance the magnetic performance of the back-iron assembly. The back iron bars can have a variety of thicknesses depending on the nature of the track, and the platform 24 is suitable for receiving back-iron components having a variety of thicknesses. Once the back-iron component 18 is cradled on the elastomer pad on the platform 24 between the two side walls 32, 34, the top cap extrusion 14 is then placed over the back-iron component 18 for clamping the back-iron component 18 between the support structure 20 and the top cap extrusion 14. More specifically, the top cap extrusion 14 is positioned over the back-iron component 18 such that the back-iron component 18 is sandwiched between the top cap extrusion 14 and the platform 24 of the support structure 20.

As shown in FIG. 3, in order to attach the top cap extrusion 14 to the support structure 20, the top cap extrusion 14 includes two channels 40a, 40b running along either side of its length and running parallel to its longitudinal axis. Each of these channels 40a, 40b is able to receive the head 44 of a fastening mechanism 46, such as the head of a bolt, as shown in FIG. 3. The channels 40a and 40b extend along the entire length of the top cap extrusion 14 such that the heads 44 of the fastening mechanisms 46 can slide within these channels 40a, 40b for being positioned at a desired location along the length of the top cap extrusion 14.

The fastening mechanisms 46 are thus slid within the channels 40a, 40b of the top cap extrusion 14 to a desired location along the length of the top cap extrusion 14 where the support structures 20 should be attached. The fastening mechanisms 46 are then positioned through the apertures 42 within the first and second fastening flanges 38a, 38b of the support structure 20, for attaching the secondary LIM rail portion 10 to a support structure 20.

Even once the fastening mechanisms 46 have been placed through the apertures 42 in the first and second fastening flanges 38a, 38b, the support structure 20 can be slid along the length of the top cap extrusion 14. In this manner, the support structures 20 are movable and adjustable in relation to the top cap extrusion 14 such that they can be located in a variety of positions along the length of the top cap extrusion 14. Once a desired position has been achieved, the fastening mechanisms 26 can be secured to the first and second fastening flanges 38a, 38b, such as via the nuts shown in FIG. 3, for example. In this manner, the top cap extrusion 14 and the back-iron component 18 of the secondary LIM rail portion 10 are attached to the support structure 20. By attaching the top cap extrusion 14 to a plurality of the support structures 20, the back-iron component 18 is sufficiently clamped in place. The attachment hardware (namely the nuts and bolts of the fastening mechanisms 46) are specified with high-tensile strength and anti-vibration characteristics designed to prevent loosening from LIM forces and restrain the back-iron position from high magnetic attraction and horizontal forces.

Between the back-iron component 18 and the support structure 20 is a thin rubber/elastomer sheet which acts to dampen magnetic vibrations causing noise between the two mating surfaces. This thin rubber/elastomer sheet is substantially equal to width of the back-iron components 18. Since the surfaces are clamped, the rubber/elastomer sheet also prevents movement (horizontal slip) between the back iron components 18 and the platform 24 of the support structure, thus ensuring a stable configuration.

As shown in FIG. 1, at the junction where two ends of the top cap extrusion 14 join together, are placed heavy cross-section and flexible electrical continuity straps 15. The cross-sectional size and shape of the straps assist to improve the performance of the propulsion system. These continuity straps 15 are generally flexible and have heavy cross-sectional shapes so as to enable improved LIM performance.

As indicated above, when the LIM vehicle travels over the secondary LIM rail portion 10, relatively high magnetic attraction forces occur between the LIM primary and LIM secondary surfaces. These forces can create high deflection stresses on the fastening mechanisms 46 that clamp the iron bar components 18 to the platform 24 of the support structure. As such, in certain cases, additional mounting brackets can be applied to the bottom face of the back-iron components. These brackets would be bolted to the support structure to aid in the reduction of the stresses that may cause premature fatigue failure of the bolted joint.

Once the secondary LIM rail portion 10 has been attached to a plurality of support structures 20, the support structures 20 are then, in turn, secured to the guideway 16. This is done via the first and second supporting flanges 26a, 26b, as shown in FIG. 5. Firstly, the first and second supporting flanges 26a, 26b of each supporting structure 20 are positioned on the guideway 16 such that their bottom surfaces 28 are in contact with the surface of the guideway 16. Based on the positioning of the support structures 20 with respect to the length of the top cap extrusion 14, the support structures 20 should be positioned on the guideway 16 in a suitable position for being secured thereto. For example, the support structures 20 may be positioned such that the apertures 30 within the first and second support flanges 26a, 26b align with anchor holes in the guideway, among other possibilities.

The ability of the support structures 20 to be movable in relation to secondary LIM rail portion 10 and attachable to the secondary LIM rail portion 10 in a variety of different locations along its length, allows flexibility in installing the secondary LIM rail portion 10 to the guideway 12. Instead of having customized LIM rail portion components, standard lengths of the top cap extrusion 14 and the back iron components 18 could be delivered to the track installation site. These standard lengths of the top cap extrusion 14 and the back iron components 18 can then be secured to irregularly shaped guideway sections or guideway sections that have uniquely positioned anchor holes, due to the adjustability and flexibility of the positioning of the support structures 20. Furthermore, in the case where the standard length of top cap extrusion and back-iron components 18 can't be used, these components can simply be cut to a desired length, which does not require skilled labor, have the ends painted, and then attached to the support structures 20 in the manner described above. As such, in cases where the top cap extrusion 14 and the back iron components 18 need to be cut to accommodate different trackwork installations, they can be cut with minimal effort and then the support structures 20 can be attached in appropriate locations along the newly cut length. Therefore, these movable support structures 20 help to avoid the need for customized secondary LIM rail portion 10 assemblies, due to their adjustability and flexibility in positioning relative to the length of the LIM rail portion 10.

Furthermore, by securing the support structures 20 to the secondary LIM rail portions 10 via fastening mechanisms 46, such as nuts and bolts, these support structures 20 permit easy change out of the back-iron components 18 when required. For example, when the LIM rail installation is being located in front of a mainline station, and a different thickness or design of back-iron component 18 is required for adjusting the thrust demand, it is not necessary to remove and replace the entire secondary LIM rail portion assembly. Instead the top can extrusion 14 can be removed, the different back-iron component 18 can be installed, and the top cap extrusion 14 can be re-attached to the support structures 20. This allows LIM rail performance to be adjusted locally with minimum effort, which saves both time and cost.

In addition, the support structures 20 according to the present invention help to prevent the wastage of materials since they are not permanently welded to the LIM rail portion. These support structures 20 can be removed from an old track installation and then re-used on a new track installation. Furthermore, these support structures 20 use less material and reduce the overall weight of the LIM rail portion assembly, when compared to traditional support structures that extend along almost the entire length of the secondary LIM rail portion 10.

In order to secure the support structures 20 to the guideway, fastening mechanisms 50 capable of engaging with the first and second supporting flanges 26a, 26b are used. The fastening mechanisms 50 can be any suitable fastening mechanism capable of securing the support structures 20 to the guideway 16, such as screws, bolts or rivets, among other possibilities. Such fastening mechanisms 50 would be known to a person of skill in the art, and as such will not be described in more detail herein. Depending on the material of the guideway 16, the fastening mechanisms 50 may be different. In the non-limiting embodiment shown, the fastening mechanisms 50 comprise bolts that are able to be threaded into anchor holes (not shown) within the guideway 16 for securing the support structures thereto.

As mentioned above, when installed to the guideway 16, the support structure 20 supports the secondary LIM rail 10 in an elevated position in relation to the guideway 16. Referring back to FIG. 2, it is the raised portion 22 of the support structure 20 that provides this elevation to the secondary LIM rail portion 10. In accordance with a non-limiting example of implementation, the raised portion 22 further defines an internal passageway 60 between the first side wall 32 and the second side wall 34, located underneath the beam 36, such that when installed, the internal passageway 60 is located between the beam 36 and the guideway 16. In order to facilitate the task of securing the secondary LIM rail portion 10 to the support structure 20, the first and second fastening flanges 38a, 38b are located outside the internal passageway 60 thus providing direct access for tightening the hardware. This avoids a worker who is attaching the support structure 20 and the secondary LIM rail portion 10 together from having to fiddle with fastening mechanisms 46 within the internal passageway 60. This makes the attachment of the secondary LIM rail portion 10 to the support structure 20 easier. Likewise, the first and second supporting flanges 26a, 26b are also located outside of the internal passageway 60 for facilitating ease of access and installation of the support structure 20 to the guideway 16. This ease of installation prevents the need for specialized tools and skills.

In the example of a trackwork installation shown in FIG. 1, the support structures 20 are attached to the secondary LIM rail portion 10 in a generally uniform, evenly-spaced manner. However, it should be appreciated that depending on the nature of the track installation, it may not be possible to position the supporting structures 20 in an even fashion along the length of the secondary LIM rail portion 10. In fact, it may be desirable, depending on factors such as how the anchor holes within the guideway 16 are spaced, to have the support structures 20 positioned in a non-uniform, non-symmetric manner. Given that the support structures 20 according to the present invention are movable in relation to the length of the secondary LIM rail portion 10 the support structures 20 can be positioned anywhere along the length of the secondary LIM rail portion 10 that would be suitable for the given track installation. In this manner, the positioning of the support structures 20 along the length of the secondary LIM rail portion 10 can be adjusted in order to accommodate irregularities in the track work.

The support structures 20 according to the present invention are suitable for being installed on-site and as such are relatively small in size for facilitating handling and transportation. These support structures can be mass produced and then finished at a low-cost facility or on-site at a track installation. The support structures 20 can also be painted or nickel plated in order to avoid premature degradation or deterioration.

As shown in FIG. 5, each support structure 20 has a length l₁ and a width w, wherein the length l₁ is greater than the width w. As such, the longitudinal axis of the support structure 20, which is illustrated via dashed line 52 in FIG. 5, extends perpendicular to an elongated direction of the secondary LIM rail portion 10.

According to a non-limiting example of implementation, each support structure 20 comprises a length l₁ that is between 400-600 mm and a width w of between 125-170 mm. In a more specific non-limiting example of implementation, each support structure 20 has a length l₁ of between 475-525 mm and a width w of between 145 mm to 160 mm. Furthermore, the length l₂ of the raised portion 22 is between 325-375 mm. As such, the length l₂ of the raised portion 22 is greater than the width w of the support structure 20. It should be appreciated that the above dimensions are provided strictly for the purposes of illustration, and should not be used to limit the scope of the present invention.

Although the present invention has been described in considerable detail with reference to certain preferred embodiments thereof, variations and refinements are possible without departing from the spirit of the invention. Therefore, the scope of the invention should be limited only by the appended claims and their equivalents.

1) A support system for a linear induction motor (LIM) rail portion, the support system comprising a plurality of support structures that are attachable at a variety of positions along a length of the LIM rail portion, each support structure comprising:
a) a raised portion defining a platform for receiving a back-iron component of the LIM rail portion;
b) first and second fastening flanges extending outwardly from respective upper sides of the raised portion, the first and second fastening flanges being attachable to a top cap extrusion of the LIM rail portion;
c) first and second supporting flanges each extending outwardly from respective bottom sides of the raised portion, for contacting a surface of the guideway to which the LIM rail portion is to be secured.

2) The support system as defined in claim 1, wherein the first and second supporting flanges each define:
i) a bottom surface for contacting the surface of the guideway; and
ii) an aperture for receiving a fastening mechanism for securing the support structure to the guideway.

3) The support system as defined in claim 1, wherein the LIM rail portion is attachable to the first fastening flange and the second fastening flange via nuts and bolts.

4) The support system as defined in claim 2, wherein the fastening mechanism comprises bolts that extend through the apertures in the first supporting flange and the second supporting flange into the guideway.

5) The support system as defined in claim 1, wherein each of the support structures comprising a width of between 125 mm and 170 mm.

6) The support structure as defined in claim 1, wherein the raised portion is nickel plated.

7) The support system as defined in claim 1, wherein each support structure defines a longitudinal axis that extends perpendicular to a longitudinal axis of the LIM rail portion when installed.

8) The support system as defined in claim 1, wherein the raised portion of each support structure defines an internal passageway underneath the platform, the internal passageway being absent any fastening mechanisms.

9) A support structure for securing a linear induction motor (LIM) rail portion to a guideway, the support structure being attachable to the LIM rail portion at a variety of positions along a length of the LIM rail portion, the support structure comprising:
a) a raised portion defining a platform for supporting the LIM rail portion;
b) a first flange portion and a second flange portion each extending outwardly from respective bottom sides of the raised portion, wherein a longitudinal axis of the support structure extends perpendicular to a longitudinal axis of the LIM rail portion.

10) The support structure of claim 9, wherein the first flange portion and the second flange portion each define:
i) a bottom surface for sitting on the guideway; and
ii) an aperture for receiving a fastening mechanism for fastening the support structure to the guideway.

11) The support structure as defined in claim 9, wherein the support structure is movable in relation to a length of LIM rail portion.

12) The support structure as defined in claim 9, further comprising:
a) a first fastening flange extending from a first side of the raised portion; and
b) a second fastening flange extending from a second side of the raised portion;
wherein the LIM rail portion is attached to the raised portion of the support structure via the first fastening flange and the second fastening flange.

13) The support structure as defined in claim 12, wherein the LIM rail portion is attached to the first fastening flange and the second fastening flange via nuts and bolts.

14) The support structure as defined in claim 10, wherein the fastening mechanism comprises bolts that extend through the apertures in the first flange portion and the second flange portion into the guideway.

15) The support structure as defined in claim 10, comprising a width of between 125 mm and 170 mm.

16) A support structure for securing a linear induction motor (LIM) rail portion to a guideway, the support structure being attachable to the LIM rail portion at a variety of positions along a length of the LIM rail portion, the support structure comprising:
a) a raised portion comprising a platform for supporting the LIM rail portion, the raised portion defining an internal passageway underneath the platform;
b) a fastening arrangement for attaching the LIM rail portion to the support structure, the fastening arrangement being positioned outside of the internal passageway.

17) The support structure as defined in claim 16, wherein the fastening arrangement comprises:
a) a first fastening flange extending from an outer surface of the raised portion in proximity to the platform; and
b) a second fastening flange extending from the outer surface of the raised portion in proximity to the platform.

18) The support structure as defined in claim 17, wherein a fastening mechanism attaches the LIM rail portion to the first fastening flange and the second fastening flange.

19) The support structure as defined in claim 16, defining a longitudinal axis that extends perpendicular to a longitudinal axis of the LIM rail portion when installed.

20) The support structure as defined in claim 10, further comprising:
a) a first supporting flange that extends outwardly from a base of a first side wall of the raised portion; and
b) a second supporting flange that extends outwardly from a base of a second side wall of the raised portion, wherein the support structure is secured to the guideway via the first supporting flange and the second supporting flange that are located outside of the internal passageway.
